(19) United States
(12) Patent Application Publication
(10) Pub. No.: US 2025/0071880 A1
(43) Pub. Date: Feb. 27, 2025

(54) EXTREME ULTRAVIOLET LIGHT GENERATION CHAMBER DEVICE AND ELECTRONIC DEVICE MANUFACTURING METHOD

(71) Applicant: Gigaphoton Inc., Tochigi (JP)

(72) Inventor: Masaki NAKANO, Oyama-shi (JP)

(73) Assignee: Gigaphoton Inc., Tochigi (JP)

(21) Appl. No.: 18/762,753

(22) Filed: Jul. 3, 2024

(30) Foreign Application Priority Data
Aug. 25, 2023 (JP) 2023-137503

(51) Int. Cl. H05G 2/00

(52) U.S. Cl. CPC H05G 2/0023; H05G 2/0035; H05G 2/0082

(57) ABSTRACT

An extreme ultraviolet light generation chamber device includes a chamber in which a target substance irradiated with laser is turned into plasma and extreme ultraviolet light is generated, a tank configured to store the target substance, a nozzle having an internal space which communicates with the tank and the chamber, an exhaust device configured to exhaust the chamber, a supply device configured to supply a purge gas to the chamber, a pressure sensor configured to measure a pressure in the chamber, and a processor. Here, the processor causes, before the target substance is melted, the exhaust device to exhaust a gas from the chamber, and after the gas is exhausted, performs supply operation to cause the supply device to supply the purge gas into the chamber and exhaust operation to cause the exhaust device to exhaust the purge gas from the chamber.

### CROSS-REFERENCE TO RELATED APPLICATIONS

The present application claims the benefit of Japanese Patent Application No. 2023-137503, filed on Aug. 25, 2023, the entire contents of which are hereby incorporated by reference.

### BACKGROUND

### 1. Technical Field

The present disclosure relates to an extreme ultraviolet light generation chamber device and an electronic device manufacturing method.

### 2. Related Art

Recently, miniaturization of a transfer pattern in optical lithography of a semiconductor process has been rapidly proceeding along with miniaturization of the semiconductor process. In the next generation, microfabrication at 10 nm or less will be required. Therefore, it is expected to develop a semiconductor exposure apparatus that combines an apparatus for generating extreme ultraviolet (EUV) light having a wavelength of about 13 nm with a reduced projection reflection optical system.

As the EUV light generation apparatus, a laser produced plasma (LPP) type apparatus using plasma generated by irradiating a target substance with laser light has been developed.

### LIST OF DOCUMENTS

### Patent Documents

Patent Document 1: U.S. Pat. No. 10,136,509

Patent Document 2: US Patent Application Publication No. 2022/0159818

Patent Document 3: U.S. Pat. No. 10,586,721

### SUMMARY

An extreme ultraviolet light generation chamber device according to an aspect of the present disclosure includes a chamber in which a target substance irradiated with laser is turned into plasma and extreme ultraviolet light is generated, a tank configured to store the target substance, a nozzle having an internal space which communicates with the tank and the chamber, an exhaust device configured to exhaust the chamber, a supply device configured to supply a purge gas to the chamber, a pressure sensor configured to measure a pressure in the chamber, and a processor. Here, the processor causes, before the target substance is melted, the exhaust device to exhaust a gas from the chamber, and after the gas is exhausted, performs supply operation to cause the supply device to supply the purge gas into the chamber and exhaust operation to cause the exhaust device to exhaust the purge gas from the chamber.

An electronic device manufacturing method according to an aspect of the present disclosure includes outputting extreme ultraviolet light generated using an extreme ultraviolet light generation apparatus including an extreme ultraviolet light generation chamber device to an exposure apparatus, and exposing a photosensitive substrate to the extreme ultraviolet light in the exposure apparatus to manufacture an electronic device. Here, the extreme ultraviolet light generation chamber device includes a chamber in which a target substance irradiated with laser is turned into plasma and the extreme ultraviolet light is generated, a tank configured to store the target substance, a nozzle having an internal space which communicates with the tank and the chamber, an exhaust device configured to exhaust the chamber, a supply device configured to supply a purge gas to the chamber, a pressure sensor configured to measure a pressure in the chamber, and a processor. The processor causes, before the target substance is melted, the exhaust device to exhaust a gas from the chamber, and after the gas is exhausted, performs supply operation to cause the supply device to supply the purge gas into the chamber and exhaust operation to cause the exhaust device to exhaust the purge gas from the chamber.

An electronic device manufacturing method according to an aspect of the present disclosure includes inspecting a defect of a mask by irradiating the mask with extreme ultraviolet light generated using an extreme ultraviolet light generation apparatus including an extreme ultraviolet light generation chamber device, selecting a mask using a result of the inspection, and exposing and transferring a pattern formed on the selected mask onto a photosensitive substrate. Here, the extreme ultraviolet light generation chamber device includes a chamber in which a target substance irradiated with laser is turned into plasma and the extreme ultraviolet light is generated, a tank configured to store the target substance, a nozzle having an internal space which communicates with the tank and the chamber, an exhaust device configured to exhaust the chamber, a supply device configured to supply a purge gas to the chamber, a pressure sensor configured to measure a pressure in the chamber, and a processor. The processor causes, before the target substance is melted, the exhaust device to exhaust a gas from the chamber, and after the gas is exhausted, performs supply operation to cause the supply device to supply the purge gas into the chamber and exhaust operation to cause the exhaust device to exhaust the purge gas from the chamber.

### BRIEF DESCRIPTION OF THE DRAWINGS

Embodiments of the present disclosure will be described below merely as examples with reference to the accompanying drawings.

FIG. 1 is a schematic view showing a schematic configuration example of an entire electronic device manufacturing apparatus.

FIG. 2 is a schematic view showing a schematic configuration example of an entire electronic device manufacturing apparatus different from the electronic device manufacturing apparatus shown in FIG. 1.

FIG. 3 is a schematic diagram showing a schematic configuration example of an entire extreme ultraviolet light generation apparatus of a comparative example.

FIG. 4 is a schematic view showing a tank at a cross section along a trajectory of a droplet target in a comparative example.

FIG. 5 is a schematic view showing the tank at a cross section along the trajectory of the droplet target in the comparative example.

FIG. 6 is a schematic diagram showing the EUV light generation apparatus of a first embodiment.

FIG. 7 is a table showing a parameter table in the first embodiment.

FIG. 8 is a graph showing the relationship between the pressure in an air gap and the elapsed time in the first embodiment.

FIG. 9 is a flowchart showing the operation of the EUV light generation apparatus of the first embodiment.

FIG. 10 is a table showing a calculation sheet according to a modification of the first embodiment.

FIG. 11 is a table showing a parameter table according to a second embodiment.

FIG. 12 is a flowchart showing the operation of the EUV light generation apparatus of the second embodiment.

FIG. 13 is a flowchart showing the operation of the EUV light generation apparatus of a third embodiment.

FIG. 14 is a flowchart showing the operation of the EUV light generation apparatus of a fourth embodiment.

FIG. 15 is a table showing examples of a second threshold in the fourth embodiment.

### DESCRIPTION OF EMBODIMENTS

1. Description of electronic device manufacturing apparatus
2. Description of extreme ultraviolet light generation apparatus of comparative example
   2.1 Configuration
   2.2 Operation
   2.3 Problem
3. Description of extreme ultraviolet light generation chamber device of first embodiment
   3.1 Configuration
   3.2 Operation
   3.3 Effect
   3.4 Description of modification
4. Description of extreme ultraviolet light generation chamber device of second embodiment
   4.1 Configuration
   4.2 Operation
   4.3 Effect
5. Description of extreme ultraviolet light generation chamber device of third embodiment
   5.1 Operation
   5.2 Effect
6. Description of extreme ultraviolet light generation chamber device of fourth embodiment
   6.1 Operation
   6.2 Effect

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Description of Electronic Device Manufacturing Apparatus

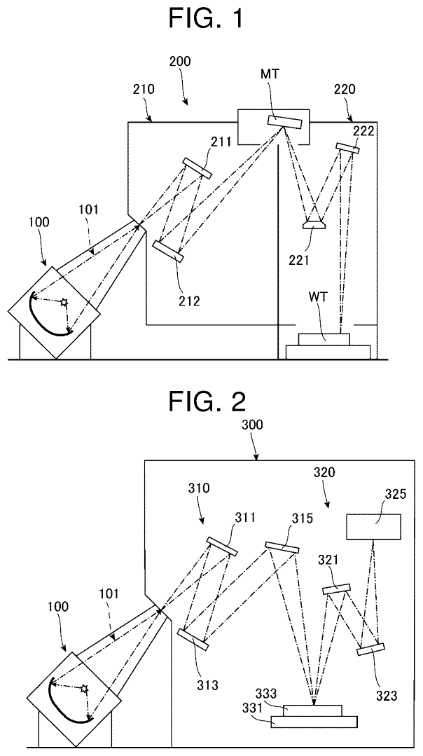

FIG. 1 is a schematic view showing a schematic configuration example of an entire electronic device manufacturing apparatus. The electronic device manufacturing apparatus shown in FIG. 1 includes an EUV light generation apparatus 100 and an exposure apparatus 200. The exposure apparatus 200 includes a mask irradiation unit 210 including a plurality of mirrors 211, 212 that configure a reflection optical system, and a workpiece irradiation unit 220 including a plurality of mirrors 221, 222 that configure a reflection optical system different from the reflection optical system of the mask irradiation unit 210. The mask irradiation unit 210 illuminates, via the mirrors 211, 212, a mask pattern of a mask table MT with EUV light 101 incident from the EUV light generation apparatus 100. The workpiece irradiation unit 220 images the EUV light 101 reflected by the mask table MT onto a workpiece (not shown) arranged on a workpiece table WT via the mirrors 221, 222. The workpiece is a photosensitive substrate such as a semiconductor wafer on which photoresist is applied. The exposure apparatus 200 synchronously translates the mask table MT and the workpiece table WT to expose the workpiece to the EUV light 101 reflecting the mask pattern. Through the exposure process as described above, a device pattern is transferred onto the semiconductor wafer, thereby a semiconductor device can be manufactured.

FIG. 2 is a schematic view showing a schematic configuration example of an entire electronic device manufacturing apparatus different from the electronic device manufacturing apparatus shown in FIG. 1. The electronic device manufacturing apparatus shown in FIG. 2 includes the EUV light generation apparatus 100 and an inspection apparatus 300. The inspection apparatus 300 includes an illumination optical system 310 including a plurality of mirrors 311, 313, 315 that configure a reflection optical system, and a detection optical system 320 including a detector 325 and a plurality of mirrors 321, 322 that configure a reflection optical system different from the reflection optical system of the illumination optical system 310. The illumination optical system 310 reflects, with the mirrors 311, 313, 315, the EUV light 101 incident from the EUV light generation apparatus 100 to illuminate a mask 333 placed on a mask stage 331. The mask 333 includes a mask blanks before a pattern is formed. The detection optical system 320 reflects, with the mirrors 321, 323, the EUV light 101 reflecting the pattern from the mask 333 and forms an image on a light receiving surface of the detector 325. The detector 325 having received the EUV light 101 acquires an image of the mask 333. The detector 325 is, for example, a time delay integration (TDI) camera. A defect of the mask 333 is inspected based on the image of the mask 333 acquired by the above-described process, and a mask suitable for manufacturing an electronic device is selected using the inspection result. Then, the electronic device can be manufactured by exposing and transferring the pattern formed on the selected mask onto the photosensitive substrate using the exposure apparatus 200.

### 2. Description of Extreme Ultraviolet Light Generation Apparatus of Comparative Example

### 2.1 Configuration

The EUV light generation apparatus 100 of a comparative example will be described. The comparative example of the present disclosure is an example recognized by the applicant as known only by the applicant, and is not a publicly known example admitted by the applicant. Further, the following description will be given with reference to the EUV light generation apparatus 100 that outputs the EUV light 101 to the exposure apparatus 200 as a subsequent process apparatus as shown in FIG. 1. Here, the EUV light generation apparatus 100 that outputs the EUV light 101 to the inspection apparatus 300 as a subsequent process apparatus as shown in FIG. 2 can obtain the same operation and effect.

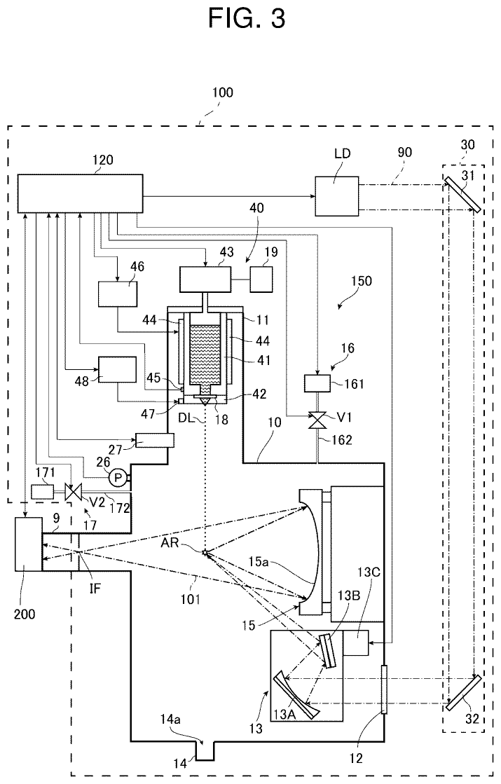

FIG. 3 is a schematic view showing a schematic configuration example of the entire EUV light generation apparatus 100 of the present example. As shown in FIG. 3, the EUV light generation apparatus 100 includes an EUV light generation chamber device 150, a laser device LD, and a laser light delivery optical system 30 as a main configuration. The EUV light generation chamber device 150 includes a chamber 10 and a processor 120 as a main configuration.

The chamber 10 is a sealable container. The chamber 10 includes a sub-chamber 11, and a target supply unit 40 is attached to the sub-chamber 11 to penetrate a wall of the sub-chamber 11. The target supply unit 40 includes a tank 41, a nozzle 42, and a pressure regulator 43 to supply a droplet target DL to the internal space of the chamber 10. The droplet target DL is sometimes abbreviated as a droplet or a target.

The tank 41 stores therein a target substance which becomes the droplet target DL. The target substance contains tin. The inside of the tank 41 is in communication with the pressure regulator 43 which adjusts the pressure in the tank 41. A heater 44 and a temperature sensor 45 are attached to the tank 41. The heater 44 heats the tank 41 with a current applied from a heater power source 46. Through the heating, the target substance in the tank 41 melts. The temperature sensor 45 measures, via the tank 41, the temperature of the target substance in the tank 41. The pressure regulator 43, the temperature sensor 45, and the heater power source 46 are electrically connected to the processor 120.

The nozzle 42 is attached to the tank 41 and outputs the target substance. The nozzle 42 has an internal space communicating from the tank 41 into the chamber 10. A piezoelectric element 47 is attached to the nozzle 42. The piezoelectric element 47 is electrically connected to a piezoelectric power source 48 and is driven by a voltage applied from the piezoelectric power source 48. The piezoelectric power source 48 is electrically connected to the processor 120. The target substance output from the nozzle 42 is formed into the droplet target DL through operation of the piezoelectric element 47.

A filter 18 is provided between the tank 41 and the nozzle 42. The filter 18 traps particles such as tin oxide when molten tin is supplied from the tank 41 to the nozzle 42.

The chamber 10 includes a target collection unit 14. The target collection unit 14 is a box body attached to the chamber 10 and communicates with the internal space of the chamber 10 through an opening 14a formed at the chamber 10. The opening 14a is arranged directly below the nozzle 42. The target collection unit 14 is a drain tank to collect any unnecessary droplet target DL having passed through the opening 14a and reaching the target collection unit 14.

The chamber 10 is provided with at least one through hole communicating with the chamber 10. The through hole is closed by a window 12. Pulse laser light 90 from the laser device LD passes through the window 12 and enters the chamber 10.

Further, a laser light concentrating optical system 13 is arranged at the internal space of the chamber 10. The laser light concentrating optical system 13 includes a laser light concentrating mirror 13A and a high reflection mirror 13B. The laser light concentrating mirror 13A reflects and concentrates the laser light 90 having transmitted through the window 12. The high reflection mirror 13B reflects the laser light 90 concentrated by the laser light concentrating mirror 13A. Positions of the laser light concentrating mirror 13A and the high reflection mirror 13B are adjusted by a laser light manipulator 13C so that a concentration position of the laser light 90 at the internal space of the chamber 10 coincides with a position specified by the processor 120. The light concentration position is adjusted to be a position directly below the nozzle 42, and when the target substance is irradiated with the laser light 90 at the light concentration position, plasma is generated from the target substance, and the EUV light 101 is radiated from the plasma. The region in which plasma is generated is sometimes referred to as a plasma generation region AR. The plasma generation region AR is a region having a radius of, for example, 40 mm about the plasma point and is located at the internal space of the chamber 10.

For example, an EUV light concentrating mirror 15 having a spheroidal reflection surface 15a is arranged at the internal space of the chamber 10. The EUV light concentrating mirror 15 includes, for example, a multilayer film in which silicon layers and molybdenum layers are alternately laminated, and reflects the EUV light 101 by the multilayer film. The EUV light concentrating mirror 15 is provided at a position not overlapping the laser light 90 at the internal space of the chamber 10. The reflection surface 15a reflects the EUV light 101 radiated from the plasma in the plasma generation region AR. The reflection surface 15a has a first focal point and a second focal point. The reflection surface 15a may be arranged such that, for example, the first focal point is located in the plasma generation region AR and the second focal point is located at an intermediate focal point IF.

The EUV light generation apparatus 100 includes a connection portion 9 providing communication between the internal space of the chamber 10 and the internal space of the exposure apparatus 200. A wall in which an aperture is formed is arranged in the connection portion 9. The wall is preferably arranged such that the aperture is located at the second focal point. The connection portion 9 is an outlet port of the EUV light 101 in the chamber 10, and the EUV light 101 is output from the connection portion 9 and enters the exposure apparatus 200.

A supply device 17 for supplying a purge gas is connected to the chamber 10. The supply device 17 supplies the purge gas into the chamber 10. For example, the purge gas is an argon gas. The supply device 17 includes a gas tank 171, a gas pipe 172, and a valve V2. The supply device 17 supplies the argon gas in the gas tank 171 into the chamber 10 as the purge gas through the gas pipe 172. The valve V2 is provided in the middle of the gas pipe 172, and controls communication between the gas tank 171 and the chamber 10. The valve V2 is electrically connected to the processor 120 and is opened and closed under control of the processor 120. The processor 120 controls supply of the purge gas into the chamber 10 by controlling the valve V2.

An exhaust device 16 for exhausting the chamber 10 is connected to the chamber 10. The exhaust device 16 exhausts a gas such as the purge gas or the atmosphere from the inside of the chamber 10. The exhaust device 16 includes a vacuum pump 161, an exhaust pipe 162, and a valve V1. The exhaust device 16 connects the vacuum pump 161 and the inside of the chamber 10 through the exhaust pipe 162 to exhaust the gas from the inside of the chamber 10. The vacuum pump 161 is electrically connected to and controlled by the processor 120. The valve V1 is provided in the middle of the exhaust pipe 162 and controls the communication between the vacuum pump 161 and the chamber 10. The valve V1 is electrically connected to the processor 120 and is opened and closed under control of the processor 120. The processor 120 controls exhaust from the inside of the chamber 10 by controlling the valve V1.

Further, the EUV light generation apparatus 100 includes a pressure sensor 26 and a detection unit 27 as a target sensor. The pressure sensor 26 and the detection unit 27 are attached to the chamber 10 and are electrically connected to the processor 120. The pressure sensor 26 measures the pressure at the internal space of the chamber 10 and outputs a signal indicating the measured pressure to the processor 120.

The detection unit 27 has, for example, an imaging function, and detects the presence, trajectory, position, velocity, and the like of the droplet target DL output from a nozzle hole of the nozzle 42 in accordance with an instruction from the processor 120. The detection unit 27 may be arranged inside the chamber 10, or may be arranged outside the chamber 10 and detect the droplet target DL through a window (not shown) arranged on a wall of the chamber 10. The detection unit 27 includes a light receiving optical system (not shown) and an imaging unit (not shown) such as a charge-coupled device (CCD) or a photodiode. In order to improve the detection accuracy of the droplet target DL, the light receiving optical system forms an image of the trajectory of the droplet target DL and the periphery thereof on a light receiving surface of the imaging unit. When the droplet target DL passes through a light concentration region of a light source (not shown) arranged to improve contrast in the field of view of the detection unit 27, the imaging unit detects a change of the light passing through the trajectory of the droplet target DL and the periphery thereof. The imaging unit converts the detected light change into a signal related to image data of the droplet target DL. The imaging unit outputs the converted signal to the processor 120.

The laser device LD includes a master oscillator being a light source to perform burst operation. The master oscillator outputs the pulse laser light 90 in a burst-on duration. The master oscillator is, for example, a solid-state laser device that excites a YAG crystal to which neodymium (Nd) or ytterbium (Yb) is added, or a laser device that outputs the laser light 90 by exciting a gas in which helium, nitrogen, or the like is mixed in a carbon dioxide gas through electric discharge. Alternatively, the master oscillator may be a quantum cascade laser device. The master oscillator may output the pulse laser light 90 by a Q switch system. Further, the master oscillator may include an optical switch, a polarizer, and the like. In the burst operation, the pulse laser light 90 is continuously output at a predetermined repetition frequency in the burst-on duration and the output of the laser light 90 is stopped in a burst-off duration. The laser device LD may include an amplifier that amplifies the laser light 90 output from the master oscillator.

The laser device LD may include a prepulse laser device which outputs prepulse laser light for misting the droplet target DL, and a main pulse laser device which outputs main pulse laser light for turning the misted droplet target DL into plasma. In this case, the laser light 90 includes the prepulse laser light and the main pulse laser light. For example, the prepulse laser device is a YAG laser device which outputs the prepulse laser light having a wavelength of 1.06 μm. Further, for example, the main pulse laser device is a YAG laser device which outputs the main pulse laser light having a wavelength of 1.06 μm or a CO₂ laser device which outputs the main pulse laser light having a wavelength of 10.6 μm.

A travel direction of the laser light 90 output from the laser device LD is adjusted by the laser light delivery optical system 30. The laser light delivery optical system 30 includes a plurality of mirrors 31, 32 for adjusting the travel direction of the laser light 90. The position of at least one of the mirrors 31, 32 is adjusted by an actuator (not shown). Owing to that the position of at least one of the mirrors 31, 32 is adjusted, the laser light 90 can appropriately propagate to the internal space of the chamber 10 through the window 12.

The processor 120 of the present disclosure is a processing device including a storage device in which a control program is stored and a central processing unit (CPU) that executes the control program. The processor 120 is specifically configured or programmed to perform various processes included in the present disclosure and controls the entire EUV light generation apparatus 100. The processor 120 receives a signal related to the pressure at the internal space of the chamber 10, which is measured by the pressure sensor 26, a signal related to image data of the droplet target DL captured by the detection unit 27, a burst signal instructing the burst operation from the exposure apparatus 200, and the like. The processor 120 processes the various signals, and may control, for example, the timing at which the droplet target DL is output, the output direction of the droplet target DL, and the like. Further, the processor 120 may control the output timing of the laser device LD, the travel direction and the concentration position of the laser light 90, and the like. Such various kinds of control described above are merely exemplary, and other control may be added as necessary, as described later.

### 2.2 Operation

Next, operation of the EUV light generation apparatus 100 of the comparative example will be described.

In the EUV light generation apparatus 100, the chamber 10 is opened, for example, at the time of new installation, maintenance, or the like. When the chamber 10 is opened, the internal space of the chamber 10 is filled with the atmosphere. At this time, the valve V1 and the valve V2 are closed.

After the chamber 10 is sealed, the processor 120 of the EUV light generation apparatus 100 activates the vacuum pump 161 to open the valve V1. The vacuum pump 161 exhausts the chamber 10 through the exhaust pipe 162. The processor 120 starts clocking after opening the valve V1. The processor 120 waits until the measured time reaches a predetermined threshold. For example, the predetermined threshold may be several tens of minutes to several hours.

When the measured time reaches the predetermined threshold, the processor 120 closes the valve V1 and opens the valve V2. When the valve V2 is opened, the gas tank 171 supplies the purge gas into the chamber 10 through the gas pipe 172. The processor 120 keeps the valve V2 open until the pressure in the chamber 10 becomes equal to or higher than a predetermined threshold. For example, the predetermined threshold is 0.1 MPa.

When the pressure in the chamber 10 becomes equal to or higher than the predetermined threshold, the processor 120 closes the valve V2 and opens the valve V1. The processor 120 keeps the valve V1 open until the pressure in the chamber 10 becomes equal to or lower than a predetermined threshold. For example, the predetermined threshold is 1E−4 Pa. When the pressure in the chamber 10 becomes equal to or lower than the predetermined threshold, the processor 120 closes the valve V1.

When the valve V1 is closed, the processor 120 causes the pressure regulator 43 to exhaust the tank 41. The processor 120 continues to exhaust the tank 41 until the pressure in the tank 41 becomes equal to or lower than a predetermined threshold. For example, the predetermined threshold is 1 Pa.

When the pressure in the tank 41 becomes equal to or lower than the predetermined threshold, the processor 120 causes the pressure regulator 43 to supply an inert gas from the gas supply source 19 into the tank 41. For example, the inert gas includes helium, argon, or the like. The processor 120 continues to supply the inert gas to the tank 41 until the pressure in the tank 41 becomes equal to or higher than a predetermined threshold. For example, the predetermined threshold is 0.1 MPa.

When the pressure in the tank 41 becomes equal to or higher than the predetermined threshold, the processor 120 causes the pressure regulator 43 to exhaust the tank 41. The processor 120 continues to exhaust the tank 41 until the pressure in the tank 41 becomes equal to or lower than a predetermined threshold. For example, the predetermined threshold is 1 Pa.

When the pressure in the tank 41 becomes equal to or lower than the predetermined threshold, the processor 120 causes the heater power source 46 to supply a current to the heater 44 to increase temperature of the heater 44 so that the target substance in the tank 41 is heated and maintained at a predetermined temperature equal to or higher than the melting point. In this case, the processor 120 controls the temperature of the target substance to the predetermined temperature by adjusting a value of the current supplied from the heater power source 46 to the heater 44 based on an output from the temperature sensor 45. When the target substance is tin, the predetermined temperature may be equal to or higher than 231.93° C. being the melting point of tin and, for example, is 240° C. or higher and 290° C. or lower. Thus, the preparation for outputting the droplet target DL is completed.

When the preparation is completed, the processor 120 causes the pressure regulator 43 to supply the inert gas from the gas supply source 19 to the tank 41 and to adjust the pressure in the tank 41 so that the molten target substance is output through the nozzle hole of the nozzle 42 at a predetermined velocity. Under this pressure, the target substance is output to the internal space of the chamber 10 through the nozzle hole of the nozzle 42. The target substance output through the nozzle hole may be in the form of jet. At this time, the processor 120 causes the piezoelectric power source 48 to apply a voltage having a predetermined waveform to the piezoelectric element 47 to generate the droplet target DL. The piezoelectric power source 48 applies the voltage so that the waveform of the voltage value becomes, for example, a sine wave, a rectangular wave, or a sawtooth wave. Vibration of the piezoelectric element 47 can propagate through the nozzle 42 to the target substance to be output through the nozzle hole of the nozzle 42. The target substance is divided at a predetermined cycle by the vibration into liquid droplet targets DL. The diameter of the droplet target DL is approximately 10 μm or more and 30 μm or less.

The droplet target DL travels to the plasma generation region AR. The detection unit 27 detects the passage timing of the droplet target DL passing through a predetermined position of the internal space of the chamber 10. The processor 120 outputs a trigger signal to control the timing of outputting the laser light 90 from the laser device LD based on the signal from the detection unit 27 so that the droplet target DL is irradiated with the laser light 90. The trigger signal output from the processor 120 is input to the laser device LD. When the trigger signal is input, the laser device LD outputs the laser light 90.

The output laser light 90 enters the laser light concentrating optical system 13 through the laser light delivery optical system 30 and the window 12. The laser light 90 travels from the laser light concentrating optical system 13 toward the plasma generation region AR. Then, the droplet target DL is irradiated with the laser light 90 in the plasma generation region AR. At this time, the processor 120 controls the laser light manipulator 13C of the laser light concentrating optical system 13 so that the laser light 90 is concentrated in the plasma generation region AR. Plasma is generated by the irradiation, and light including the EUV light 101 is radiated from the plasma.

Among the light including the EUV light 101 generated in the plasma generation region AR, a part of the EUV light 101 travels to the EUV light concentrating mirror 15, is concentrated at the intermediate focal point IF by the EUV light concentrating mirror 15, and then, enters the exposure apparatus 200 from the connection portion 9.

### 2.3 Problem

When the output operation of the droplet target DL from the nozzle 42 of the target supply unit 40 is completed, the processor 120 stops the heater 44. When the heater 44 stops, the target substance is cooled and solidified.

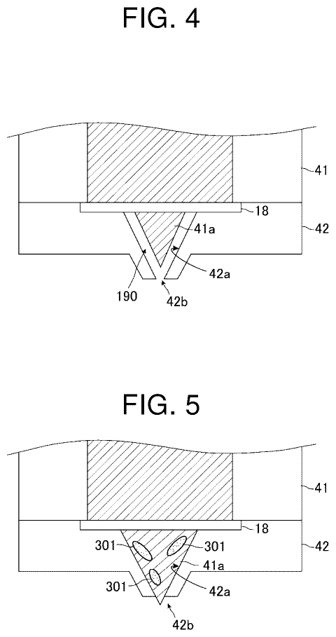

FIG. 4 shows the target supply unit 40, with the target substance 41a solidified, at a cross section along the trajectory of the droplet target DL. The nozzle 42 includes an inner wall 42a of the internal space and a nozzle hole 42b connected to the inside of the chamber 10.

When the target substance 41a is tin, a volume shrinkage of about 4% occurs when the molten target substance 41a is cooled and solidified. As shown in FIG. 4, the target substance 41a filled between the filter 18 and the nozzle hole 42b of the nozzle 42 in a molten state separates from the inner wall 42a of the nozzle 42 as being shrunken through solidification. Consequently, an air gap 190 may be formed between the solidified target substance 41a and the inner wall 42a.

When the chamber 10 is opened to the atmosphere in a state in which the air gap 190 is formed, the atmosphere enters the air gap 190. Since oxygen is contained in the atmosphere, oxygen also enters the air gap 190.

When the droplet target DL is to be output from the target supply unit 40, the processor 120 increases the temperature of the heater 44 again with oxygen entered the air gap 190.

FIG. 5 shows the target supply unit 40 in the case in which the processor 120 increases the temperature of the heater 44 again in the same manner as in FIG. 4. The target substance 41a contained in the internal space of the nozzle 42 is heated and melted by the temperature rise of the heater 44. Tin being the target substance 41a has a property of reacting with oxygen to be oxidized when melted. Therefore, as shown in FIG. 5, tin oxide 301 is generated in the nozzle 42 through reaction between oxygen and tin.

Consequently, the nozzle hole 42b may be clogged by the tin oxide 301, or a part of the nozzle hole 42b may be blocked by the tin oxide 301, and the trajectory of the droplet target DL may become unstable.

Therefore, in the following embodiments, the EUV light generation chamber device 150 capable of suppressing the generation of tin oxide in the nozzle 42 is exemplified.

### 3. Description of Extreme Ultraviolet Light Generation Chamber Device of First Embodiment

The configuration of the EUV light generation apparatus 100 of a first embodiment will be described. Any component same as that described above is denoted by an identical reference sign, and duplicate description thereof is omitted unless specific description is needed.

### 3.1 Configuration

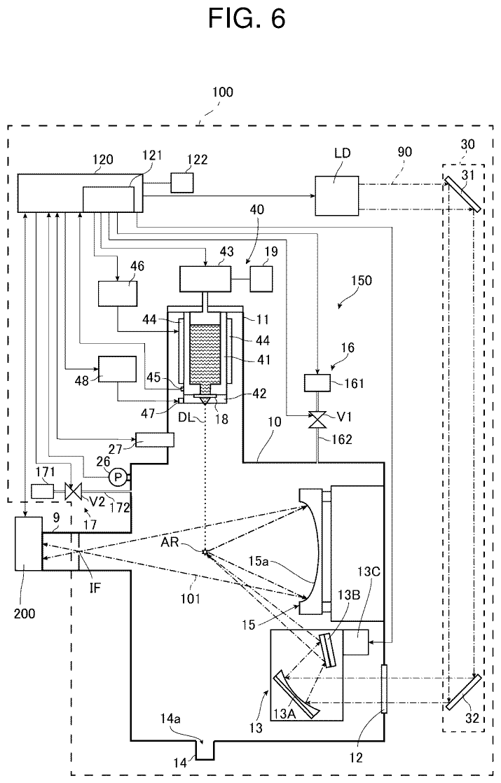

FIG. 6 is a schematic diagram showing the EUV light generation apparatus 100 of the present embodiment. The EUV light generation apparatus 100 of the present embodiment mainly differs from the EUV light generation apparatus 100 of the comparative example in that the processor 120 includes a parameter storage unit 121.

In the present embodiment, the EUV light generation apparatus 100 further includes an operation unit 122. The operation unit 122 is electrically connected to the processor 120. The operation unit 122 receives an input of operation from an operator. The operation unit 122 transmits a signal related to the input operation to the processor 120. For example, the operation unit 122 is a keyboard, a mouse, a touch panel, or a combination thereof.

The parameter storage unit 121 non-temporarily stores a parameter table in advance. The parameter storage unit 121 is a non-transitory recording medium, and is preferably a semiconductor recording medium such as a read only memory (ROM). However, the storage device may include a recording medium of an arbitrary type such as an optical recording medium or a magnetic recording medium. Here, the non-transitory recording medium includes all computer-readable recording media except for a transitory propagating signal.

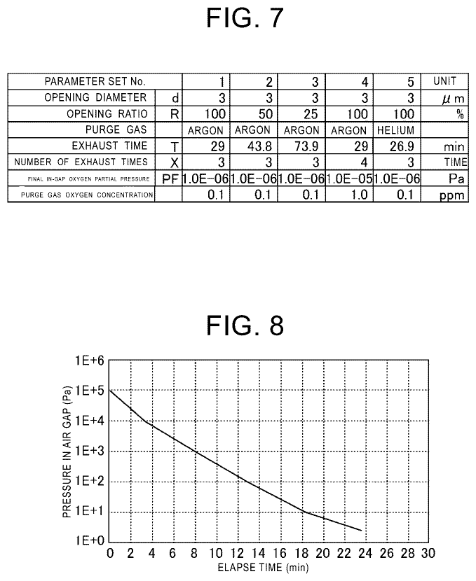

Next, the parameter table will be described. FIG. 7 shows the parameter table stored in the parameter storage unit 121.

The parameter table indicates a plurality of parameter sets related to the operation of the EUV light generation apparatus 100. In the example shown in FIG. 7, each parameter set indicates an opening diameter and an opening ratio of the nozzle hole 42b, a type of the purge gas, and an exhaust time T and a number of exhaust times X according to an oxygen concentration of the purge gas.

The opening ratio is the aperture ratio of the nozzle hole 42b. In the present embodiment, the opening ratio is a ratio of the transmission area to the area of the nozzle hole 42b on the projection surface in the direction in which the droplet target DL is output. The transmission area is an area of a region through which the target substance 41a can be transmitted. For example, when a part of the nozzle hole 42b is blocked by tin oxide or the like, the transmission area decreases.

The exhaust time is a time period during which the processor 120 causes the exhaust device 16 to exhaust the chamber 10.

The number of exhaust times is the number of times for which the processor 120 causes the exhaust device 16 to exhaust the chamber 10. In the present embodiment, the number of exhaust times X is a value obtained by adding, to 1 being the number of times the exhaust device 16 exhausts the atmosphere, the number of times the purge gas is exhausted thereafter.

A final in-gap oxygen partial pressure PF is an oxygen partial pressure in the air gap 190 after the processor 120 causes the exhaust device 16 to perform exhausting the number of exhaust times X.

The oxygen partial pressure of the purge gas is a partial pressure of oxygen contained in the purge gas.

The parameters are set as follows. A parameter set 1 will be described as an example. That is, description will be provided on a case in which the nozzle hole 42b has a diameter of 3 μm and an opening ratio of 100%, the purge gas is an argon gas, and the oxygen concentration in the purge gas is 0.1 ppm. In the present embodiment, repeating the exhaust of the chamber 10 and the supply of the purge gas is referred to as cycle purge.

The parameters are set such that the oxygen partial pressure in the air gap 190 is lower than a first threshold. In the present embodiment, the first threshold is 1E−5 Pa. Tin having a temperature of a melting point or higher has a property of rapidly oxidizing when being contacted with a gas having an oxygen partial pressure of 1E−5 Pa or higher. Therefore, when the oxygen partial pressure in the air gap 190 is set to be lower than 1E−5 Pa, generation of tin oxide can be effectively suppressed even when the tin melts.

As described above, when the target substance 41a is solidified, a volume shrinkage of 4% occurs.

Further, the exhaust device 16 lowers the pressure in the chamber 10 to 1E−4 Pa being a second threshold or lower. The oxygen partial pressure of the atmosphere is 20260 Pa, and the oxygen concentration of the purge gas is 0.1 ppm. The processor 120 also maintains the pressure in the chamber 10 after reducing the pressure in the chamber 10 to 1E−4 Pa or lower until the pressure in the air gap 190 becomes equal to or lower than 10 Pa being a third threshold. The third threshold is approximately five orders of magnitude greater than the second threshold.

In the present embodiment, a time period from when the pressure in the chamber 10 becomes 1E−4 Pa until when the pressure in the air gap 190 filled with the atmosphere of 1 atmospheric pressure (atm) becomes 10 Pa is referred to as an atmosphere exhaust time t1. Further, a time period from when the pressure in the chamber 10 becomes 1E−4 Pa until when the pressure in the air gap 190 filled with the purge gas of 1 atm becomes 10 Pa is referred to as a purge gas exhaust time t2. 1 atm is 101300 Pa.

FIG. 8 shows pressure change in the air gap 190 from the beginning of exhaust when the pressure in the chamber 10 is 1E−4 Pa. The air gap 190 is filled with the atmosphere of 1 atm in the initial state. In FIG. 8, the horizontal axis represents elapse time, and the vertical axis represents the pressure in the air gap 190. As shown in FIG. 8, the pressure in the air gap 190 decreases over time. In the example shown in FIG. 8, the pressure in the air gap 190 becomes 10 Pa after 18 minutes elapsed. Therefore, the atmosphere exhaust time t1 is 18 minutes.

The graph of FIG. 8 may be obtained experimentally or by calculation. Further, the graph of FIG. 8 may be calculated from the result of an experiment with which a part of the situation can be simulated. Similarly, the purge gas exhaust time t2 is determined.

The exhaust time T is determined based on the time period until the pressure in the chamber 10 becomes 1E−4 Pa by the exhaust device 16, the atmosphere exhaust time t1, and the purge gas exhaust time t2.

In the present embodiment, the sum of the time period until when the pressure in the chamber 10 filled with the atmosphere of 1 atm is brought to 1E−4 Pa by the exhaust device 16 and the atmosphere exhaust time t1 is referred to as an atmosphere exhaust time T1. The atmosphere exhaust time T1 is also referred to as a first exhaust time.

Further, the sum of the time period until when the pressure in the chamber 10 filled with the purge gas of 1 atm is brought to 1E−4 Pa and the purge gas exhaust time t2 is referred to as a purge gas exhaust time T2. The purge gas exhaust time T2 is also referred to as a second exhaust time.

The exhaust time T is the larger of the atmosphere exhaust time T1 and the purge gas exhaust time T2. In the present embodiment, the exhaust time T is the time period required to bring the pressure in the air gap 190 to 10 Pa even when the chamber 10 is filled with any of the atmosphere and the purge gas.

For example, the time period required for the exhaust device 16 to bring the pressure in the chamber 10 filled with the atmosphere or the purge gas of 1 atm to 1E−4 Pa is several tens of minutes to several hours.

Next, the number of exhaust times X will be described. When the chamber 10 filled with the atmosphere of 1 atm is exhausted by the exhaust device 16 for the exhaust time T as the first exhaust, the pressure in the air gap 190 becomes 10 Pa, and the oxygen partial pressure in the air gap 190 becomes 2.0 Pa.

In this state, when the purge gas is supplied, as the first purge gas supply, by the supply device 17 until the pressure in the chamber 10 becomes 1 atm being a fourth threshold, the pressure in the air gap 190 also becomes 1 atm. At this time, the oxygen partial pressure in the air gap 190 is the sum of the oxygen partial pressure 2.0 Pa derived from the atmosphere and the oxygen partial pressure 0.01013 Pa derived from the purge gas, as shown in the following equation.

Oxygen partial pressure in the air gap 190=2.0 Pa+0.01013 Pa=2.01013 Pa

In this state, when the chamber 10 filled with the purge gas of 1 atm is exhausted by the exhaust device 16 for the exhaust time T as the second exhaust, the pressure in the air gap 190 becomes 10 Pa again, and the oxygen partial pressure in the air gap 190 becomes 1.91E−4 Pa.

Next, when the purge gas is supplied, as the second purge gas supply, by the supply device 17 until the pressure in the chamber 10 becomes 1 atm, the pressure in the air gap 190 also becomes 1 atm. At this time, the oxygen partial pressure in the air gap 190 is the sum of the original oxygen partial pressure 1.91E−4 Pa and the oxygen partial pressure 0.01013 Pa derived from the purge gas, as shown in the following equation.

Oxygen partial pressure in the air gap 190=1.91E−4 Pa+0.01013 Pa=1.03E−2 Pa

Next, when the chamber 10 filled with the purge gas of 1 atm is exhausted by the exhaust device 16 for the exhaust time T as the third exhaust, the pressure in the air gap 190 becomes 10 Pa again, and the oxygen partial pressure in the air gap 190 becomes 1.02E−6 Pa.

At this time, the oxygen partial pressure in the air gap 190 is equal to or lower than the first threshold, and thus the number of exhaust times X is determined to be three.

As described above, the cycle purge consisting of three times of exhaust and two times of purge gas supply allows the oxygen partial pressure in the air gap 190 to be lower than the first threshold being 1E−5 Pa. In the present embodiment, since the cycle purge is completed in the exhausted state, the number of exhaust times is one more than the number of purge gas supply times.

Similarly to the above, other parameter sets are also determined. The number of parameter sets included in the parameter table is not limited to a specific number.

### 3.2 Operation

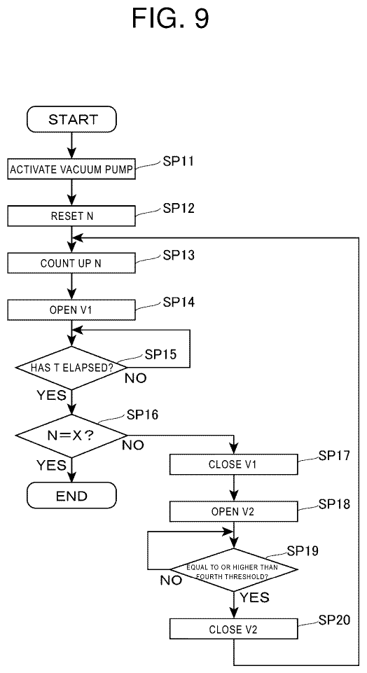

Next, operation of the EUV light generation apparatus 100 of the present embodiment will be described. FIG. 9 is a flowchart for explaining the operation of the EUV light generation apparatus 100. The processor 120 actualizes the following operation by executing a program stored in an internal memory or the like. As shown in FIG. 9, the flowchart includes steps SP11 to SP20.

At the beginning of the flowchart explained below, the chamber 10 is filled with the atmosphere of 1 atm, and the valve V1 and the valve V2 are closed. Further, the processor 120 receives operation of selecting a parameter set from an operator via the operation unit 122, and sets one parameter set from the parameter table in accordance with the operation.

(Step SP11) The present step is a step in which the processor 120 of the EUV light generation apparatus 100 activates the vacuum pump 161. The processor 120 may activate the vacuum pump 161 according to operation from an operator or the like, or may activate the vacuum pump 161 after the parameters are set. After activating the vacuum pump 161, the processor 120 proceeds to step SP12.

(Step SP12) The present step is a step in which the processor 120 resets an exhaust count N for counting the exhaust with the exhaust device 16. The processor 120 substitutes 0 for the exhaust count N. After substituting 0 for the exhaust count N, the processor 120 proceeds to step SP13.

(Step SP13) The present step is a step in which the processor 120 counts up the exhaust count N. The processor 120 adds 1 to the exhaust count N. After adding 1 to the exhaust count N, the processor 120 proceeds to step SP14.

(Step SP14) The present step is a step in which the processor 120 opens the valve V1 and causes the exhaust device 16 to start exhaust. After opening the valve V1, the processor 120 proceeds to step SP15.

(Step SP15) The present step is a step in which the processor 120 determines whether the exhaust time T has elapsed since the opening of the valve V1. The processor 120 starts clocking after step SP14 and determines whether the measured time period exceeds the exhaust time T.

When the measured time period does not exceed the exhaust time T, the processor 120 returns to step SP15. When the measured time period exceeds the exhaust time T, the processor 120 proceeds to step SP16.

(Step SP16) The present step is a step in which the processor 120 determines whether the exhaust count N matches the number of exhaust times X. That is, the processor 120 determines whether the number of exhaust times by the exhaust device 16 has reached the number of exhaust times X.

When the exhaust count N matches the number of exhaust times X, the processor 120 ends the flowchart. When the exhaust count N does not match the number of exhaust times X, the processor 120 proceeds to step SP17.

(Step SP17) The present step is a step in which the processor 120 closes the valve V1. After closing the valve V1, the processor 120 proceeds to step SP18.

(Step SP18) The present step is a step in which the processor 120 opens the valve V2 and causes the supply device 17 to start supplying the purge gas. After opening the valve V2, the processor 120 proceeds to step SP19.

(Step SP19) The present step is a step in which the processor 120 determines whether the pressure measured by the pressure sensor 26 is equal to or higher than 1 atm being the fourth threshold. When the measured pressure is equal to or higher than 1 atm, that is, when the pressure in the chamber 10 is equal to or higher than 1 atm, the processor 120 proceeds to step SP20. When the measured pressure is lower than 1 atm, that is, when the pressure in the chamber 10 is lower than 1 atm, the processor 120 returns to step SP19.

(Step SP20) The present step is a step in which the processor 120 closes the valve V2. After closing the valve V2, the processor 120 returns to step SP13.

Note that the processor 120 may cause the pressure regulator 43 to exhaust the tank 41 and maintain the pressure in the tank 41 low while executing steps SP11 to SP20.

In the present embodiment, the operation until YES is obtained through steps SP14 to SP15 when the chamber 10 is filled with the purge gas is referred to as exhaust operation. Further, the operation until YES is obtained through steps SP18 to SP19 is referred to as supply operation.

When YES is obtained in step SP16, the processor 120 causes the heater power source 46 to supply a current to the heater 44 to increase the temperature of the heater 44 so that the target substance 41a in the tank 41 is heated and maintained at a predetermined temperature equal to or higher than the melting point as in the comparative example. When tin melts, the droplet target DL is ready to be output.

When the preparation is completed, the processor 120 causes the pressure regulator 43 to supply the inert gas from the gas supply source 19 to the tank 41 and to adjust the pressure in the tank 41 so that the molten target substance 41a is output through the nozzle hole 42b of the nozzle 42 at a predetermined velocity. Under this pressure, the target substance 41a is output to the internal space of the chamber 10 through the nozzle hole 42b of the nozzle 42. At this time, the processor 120 causes the piezoelectric power source 48 to apply a voltage having a predetermined waveform to the piezoelectric element 47 to generate the droplet target DL.

When the droplet target DL is output, the processor 120 outputs, based on the signal from the detection unit 27, a trigger signal to control the timing of outputting the laser light 90 from the laser device LD so that the droplet target DL is irradiated with the laser light 90. The trigger signal output from the processor 120 is input to the laser device LD. When the trigger signal is input, the laser device LD outputs the laser light 90.

The output laser light 90 enters the laser light concentrating optical system 13 through the laser light delivery optical system 30 and the window 12. The laser light 90 travels from the laser light concentrating optical system 13 toward the plasma generation region AR. Then, the droplet target DL is irradiated with the laser light 90 in the plasma generation region AR. Plasma is generated by the irradiation, and light including the EUV light 101 is radiated from the plasma.

Among the light including the EUV light 101 generated in the plasma generation region AR, a part of the EUV light 101 travels to the EUV light concentrating mirror 15, is concentrated at the intermediate focal point IF by the EUV light concentrating mirror 15, and then, enters the exposure apparatus 200 from the connection portion 9.

### 3.3 Effect

In the EUV light generation apparatus 100, before the tin contained in the target substance 41a is melted, the atmosphere is exhausted from the chamber 10, the purge gas is supplied to the chamber 10, and the purge gas is exhausted. The EUV light generation apparatus 100 operates as described above such that the oxygen partial pressure in the air gap 190 between the tin contained in the target substance 41a and the inner wall 42a in the nozzle 42 is lower than the first threshold. Therefore, the EUV light generation apparatus 100 may set the oxygen partial pressure of the gas contacting the target substance 41a in the nozzle 42 to be equal to or lower than the first threshold. Consequently, the EUV light generation apparatus 100 can prevent oxygen from contacting the molten target substance 41a in a case in which the target substance 41a is heated and melted even when the air gap 190 is formed between the target substance 41a and the inner wall 42a in the nozzle 42. Therefore, the EUV light generation apparatus 100 can suppress generation of tin oxide in the nozzle 42.

Here, the first threshold is 1E−5 Pa. As described above, molten tin is rapidly oxidized when contacting a gas whose oxygen partial pressure is equal to or higher than 1E−5 Pa. Therefore, by setting the oxygen partial pressure in the air gap 190 to be less than 1E−5 Pa, the EUV light generation apparatus 100 can more effectively suppress generation of tin oxide.

Here, the processor 120 may receive, as an input, at least one of the exhaust time T and the number of exhaust times X from the operator.

Further, prior to step SP11, the chamber 10 may be filled with a gas other than the atmosphere, such as the purge gas.

The numerical values of the first to fourth thresholds described above are examples, and are not limited to specific values. Further, the number of exhaust times X may be 1. The number of exhaust times X is not limited to a specific value.

### 3.4 Description of Modification

Next, the EUV light generation apparatus 100 of a modification of the first embodiment will be described. Any component same as that described above is denoted by an identical reference sign, and duplicate description thereof is omitted unless specific description is needed.

The EUV light generation apparatus 100 according to the modification differs from the EUV light generation apparatus 100 according to the first embodiment in that the exhaust time T and the number of exhaust times X are calculated based on the information input from an operator.

The processor 120 displays a calculation sheet on a monitor (not shown). For example, the calculation sheet is created by spreadsheet software or the like.

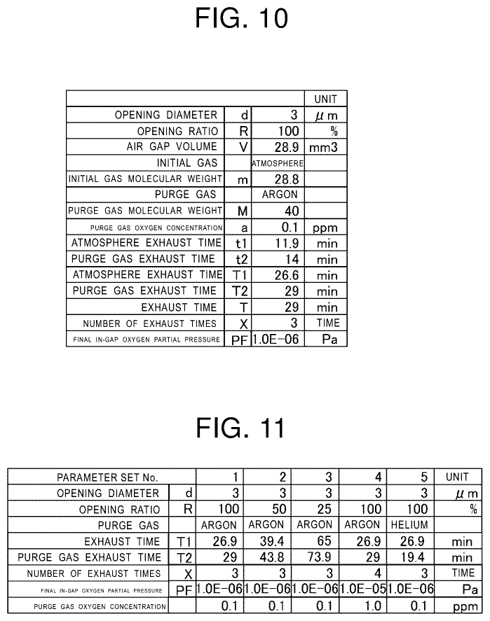

FIG. 10 shows a calculation sheet displayed by the processor 120. In the example shown in FIG. 10, the calculation sheet receives inputs of “opening diameter”, “opening ratio”, “air gap volume”, “initial gas”, “purge gas”, and “purge gas oxygen concentration”.

The “opening diameter” is a diameter of the nozzle hole 42b. The “opening ratio” is the aperture ratio of the nozzle hole 42b. The “air gap volume” is a volume of the air gap 190. The “initial gas” is a gas that fills the chamber 10 in the initial state. The “purge gas” is a type of the purge gas to be supplied by the supply device 17.

In the example shown in FIG. 10, the processor 120 receives inputs of 3 μm, 100%, 28.9 mm, atmosphere, argon, and 0.1 ppm as “opening diameter”, “opening ratio”, “air gap volume”, “initial gas”, “purge gas”, and “purge gas oxygen concentration”, respectively, via the operation unit 122.

When the “initial gas” is input, the processor 120 displays or updates the “initial gas molecular weight” based on the input gas. The “initial gas molecular weight” is the molecular weight of the input gas.

Further, when the “purge gas” is input, the processor 120 displays or updates the “purge gas molecular weight” based on the type of the input purge gas. The “purge gas molecular weight” is the molecular weight of the type of the purge gas.

Upon receiving the information described above, the processor 120 calculates the atmosphere exhaust time t1 from the “opening diameter”, the “opening ratio”, the “air gap volume”, and the “initial gas molecular weight” according to a predetermined algorithm. The processor 120 displays the calculated atmosphere exhaust time t1 as the “atmosphere exhaust time” on the calculation sheet.

Further, the processor 120 calculates the purge gas exhaust time t2 from the “opening diameter”, the “opening ratio”, the “air gap volume”, and the “purge gas molecular weight” according to a predetermined algorithm. The processor 120 displays the calculated purge gas exhaust time t2 as the “purge gas exhaust time” on the calculation sheet.

Further, the processor 120 calculates the atmosphere exhaust time T1 from the atmosphere exhaust time t1. For example, the processor 120 adds a predetermined time period to the atmosphere exhaust time t1 to calculate the atmosphere exhaust time T1. The predetermined time is, for example, several tens of minutes to several hours. After calculating the atmosphere exhaust time T1, the processor 120 displays the calculated atmosphere exhaust time T1 as the “atmosphere exhaust time” on the calculation sheet.

Further, the processor 120 calculates the purge gas exhaust time T2 from the purge gas exhaust time t2. For example, the processor 120 adds a predetermined time period to the purge gas exhaust time t2 to calculate the purge gas exhaust time T2. After calculating the purge gas exhaust time T2, the processor 120 displays the calculated purge gas exhaust time T2 as the “purge gas exhaust time” on the calculation sheet.

After calculating the atmosphere exhaust time T1 and the purge gas exhaust time T2, the processor 120 acquires the larger one of the above as the exhaust time T. After acquiring the exhaust time T, the processor 120 displays the exhaust time T as the “exhaust time” on the calculation sheet.

Further, the processor 120 calculates the number of exhaust times X and the final in-gap oxygen partial pressure from the “opening diameter”, the “opening ratio”, the “air gap volume”, and the “initial gas molecular weight” according to a predetermined algorithm. The processor 120 displays the calculated number of exhaust times X and the calculated final in-gap oxygen partial pressure PF as the “number of exhaust times” and the “final in-gap oxygen partial pressure” on the calculation sheet.

Upon receiving an input of operation of determining parameters from the operator via the operation unit 122, the processor 120 sets the calculated exhaust time T and the calculated number of exhaust times X. After setting the exhaust time T and the number of exhaust times X, the processor 120 executes the flowchart of FIG. 9 as in the first embodiment.

The processor 120 may receive, as an input, at least one of the “initial gas molecular weight” and the “purge gas molecular weight” via the operation unit 122.

The EUV light generation apparatus 100 according to the modification calculates and sets parameters from the “opening diameter”, the “opening ratio”, the “air gap volume”, the “initial gas”, the “purge gas”, and the “purge gas oxygen concentration”. Therefore, the EUV light generation apparatus 100 can flexibly set appropriate parameters even when conditions such as the “opening diameter”, the “opening ratio”, the “air gap volume”, the “initial gas”, the “purge gas”, and the “purge gas oxygen concentration” are changed. Therefore, the EUV light generation apparatus 100 can appropriately reduce the oxygen partial pressure in the air gap 190 and suppress generation of tin oxide even when the conditions are changed.

### 4. Description of Extreme Ultraviolet Light Generation Chamber Device of Second Embodiment

Next, the configuration of the EUV light generation apparatus 100 of a second embodiment will be described. Any component same as that described above is denoted by an identical reference sign, and duplicate description thereof is omitted unless specific description is needed.

The EUV light generation apparatus 100 of the second embodiment differs from the EUV light generation apparatus 100 of the first embodiment in that the time period for causing the exhaust device 16 to exhaust the chamber 10 differs between the case in which the chamber 10 is filled with the atmosphere and the case in which the chamber 10 is filled with the purge gas.

### 4.1 Configuration

FIG. 11 shows a parameter table stored in advance in the parameter storage unit 121 according to the second embodiment. As shown in FIG. 11, the parameter table indicates an opening diameter and an opening ratio of the nozzle hole 42b, and the atmosphere exhaust time T1, the purge gas exhaust time T2, and the number of exhaust times X according to the type of the purge gas. In the present embodiment, the atmosphere exhaust time T1 differs from the purge gas exhaust time T2.

### 4.2 Operation

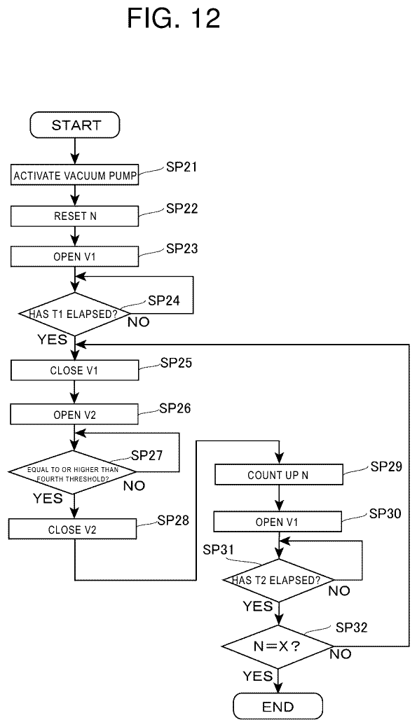

Next, operation of the EUV light generation apparatus 100 of the present embodiment will be described. FIG. 12 is a flowchart for explaining the operation of the EUV light generation apparatus 100. The processor 120 actualizes the following operation by executing a program stored in an internal memory or the like. As shown in FIG. 12, the flowchart includes steps SP21 to SP32.

At the beginning of the flowchart explained below, the chamber 10 is filled with the atmosphere of 1 atm, and the valve V1 and the valve V2 are closed. Further, the processor 120 receives operation of selecting a parameter set from an operator via the operation unit 122, and sets one parameter set from the parameter table in accordance with the operation.

(Step SP21) The present step is a step in which the processor 120 of the EUV light generation apparatus 100 activates the vacuum pump 161. After activating the vacuum pump 161, the processor 120 proceeds to step SP22.

(Step SP22) The present step is a step in which the processor 120 resets the exhaust count N for counting the exhaust the exhaust device 16. The processor 120 substitutes 1 for the exhaust count N. After substituting 1 for the exhaust count N, the processor 120 proceeds to step SP23.

(Step SP23) The present step is a step in which the processor 120 opens the valve V1 and causes the exhaust device 16 to start exhaust. After opening the valve V1, the processor 120 proceeds to step SP24.

(Step SP24) The present step is a step in which the processor 120 determines whether the atmosphere exhaust time T1 has elapsed since the opening of the valve V1. The processor 120 starts clocking after step SP23 and determines whether the measured time period exceeds the atmosphere exhaust time T1.

When the measured time period does not exceed the atmosphere exhaust time T1, the processor 120 returns to step SP24. When the measured time period exceeds the atmosphere exhaust time T1, the processor 120 proceeds to step SP25.

(Step SP25) The present step is a step in which the processor 120 closes the valve V1. After closing the valve V1, the processor 120 proceeds to step SP26.

(Step SP26) The present step is a step in which the processor 120 opens the valve V2 and causes the supply device 17 to start supplying the purge gas. After opening the valve V2, the processor 120 proceeds to step SP27.

(Step SP27) The present step is a step in which the processor 120 determines whether the pressure measured by the pressure sensor 26 is equal to or higher than 1 atm being the fourth threshold. When the measured pressure is equal to or higher than 1 atm, that is, when the pressure in the chamber 10 is equal to or higher than 1 atm, the processor 120 proceeds to step SP28. When the measured pressure is lower than 1 atm, that is, when the pressure in the chamber 10 is lower than 1 atm, the processor 120 returns to step SP27.

(Step SP28) The present step is a step in which the processor 120 closes the valve V2. After closing the valve V2, the processor 120 proceeds to step SP29.

(Step SP29) The present step is a step in which the processor 120 counts up the exhaust count N. The processor 120 adds 1 to the exhaust count N. After adding 1 to the exhaust count N, the processor 120 proceeds to step SP30.

(Step SP30) The present step is a step in which the processor 120 opens the valve V1 and causes the exhaust device 16 to start exhaust. After opening the valve V1, the processor 120 proceeds to step SP31.

(Step SP31) The present step is a step in which the processor 120 determines whether the purge gas exhaust time T2 has elapsed since the opening of the valve V1. The processor 120 starts clocking after step SP30 and determines whether the measured time period exceeds the purge gas exhaust time T2.

When the measured time period does not exceed the purge gas exhaust time T2, the processor 120 returns to step SP31. When the measured time period exceeds the purge gas exhaust time T2, the processor 120 proceeds to step SP32.

(Step SP32) The present step is a step in which the processor 120 determines whether the exhaust count N matches the number of exhaust times X. That is, the processor 120 determines whether the number of exhaust times by the exhaust device 16 has reached the number of exhaust times X.

When the exhaust count N matches the number of exhaust times X, the processor 120 ends the flowchart. When the exhaust count N does not match the number of exhaust times X, the processor 120 returns to step SP25.

In the present embodiment, the operation until YES is obtained through steps SP30 to SP31 is referred to as the exhaust operation. Further, the operation until YES is obtained through steps SP26 to SP27 is referred to as the supply operation.

When YES is obtained in step SP32, the processor 120 generates the EUV light 101 as in the first embodiment.

### 4.3 Effect

In the EUV light generation apparatus 100, exhaust is continued for the atmosphere exhaust time T1 when the atmosphere is exhausted from the chamber 10, and exhaust is continued for the purge gas exhaust time T2 when the purge gas is exhausted from the chamber 10. Therefore, compared with the case in which exhaust is continued for the exhaust time T regardless of the gas filling the chamber 10, the EUV light generation apparatus 100 can make the oxygen partial pressure in the air gap 190 equal to or lower than the first threshold in a short time. Therefore, the EUV light generation apparatus 100 can suppress the time required to start generating the EUV light 101.

Here, the processor 120 may calculate and set the atmosphere exhaust time T1 and the purge gas exhaust time T2 based on the input data as in the modification of the first embodiment.

### 5. Description of Extreme Ultraviolet Light Generation Chamber Device of Third Embodiment

Next, the configuration of the EUV light generation apparatus 100 of a third embodiment will be described. Any component same as that described above is denoted by an identical reference sign, and duplicate description thereof is omitted unless specific description is needed.

The EUV light generation apparatus 100 of the third embodiment differs from the EUV light generation apparatus 100 of the first embodiment in detecting the pressure in the chamber 10 having become 1E−4 Pa in the exhaust operation.

### 5.1 Operation

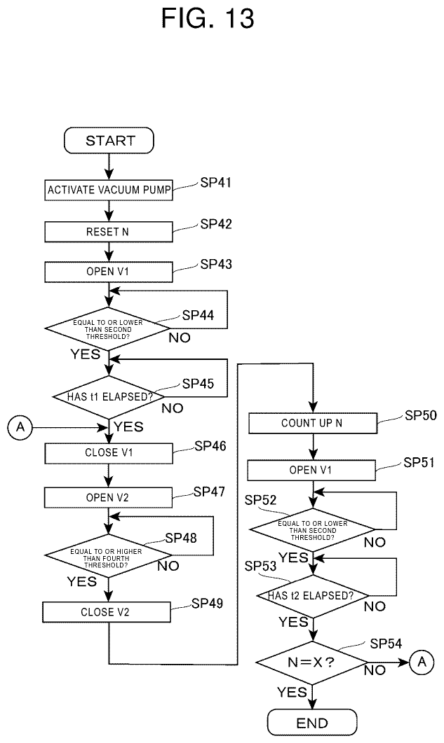

Operation of the EUV light generation apparatus 100 of the present embodiment will be described. FIG. 13 is a flowchart for explaining the operation of the EUV light generation apparatus 100. The processor 120 actualizes the following operation by executing a program stored in an internal memory or the like. As shown in FIG. 13, the flowchart includes steps SP41 to SP54.

At the beginning of the flowchart explained below, the chamber 10 is filled with the atmosphere of 1 atm, and the valve V1 and the valve V2 are closed. In the present embodiment, the parameter table indicates the atmosphere exhaust time t1 and the purge gas exhaust time t2, and the processor 120 may set the atmosphere exhaust time t1 and the purge gas exhaust time t2 by referring to the parameter table.

(Step SP41) The present step is a step in which the processor 120 of the EUV light generation apparatus 100 activates the vacuum pump 161. After activating the vacuum pump 161, the processor 120 proceeds to step SP42.

(Step SP42) The present step is a step in which the processor 120 resets the exhaust count N for counting the exhaust with the exhaust device 16. The processor 120 substitutes 1 for the exhaust count N. After substituting 1 for the exhaust count N, the processor 120 proceeds to step SP43.

(Step SP43) The present step is a step in which the processor 120 opens the valve V1 and causes the exhaust device 16 to start exhaust. After opening the valve V1, the processor 120 proceeds to step SP44.

(Step SP44) The present step is a step in which the processor 120 determines whether the pressure measured by the pressure sensor 26 is equal to or lower than 1E−4 Pa being the second threshold. When the measured pressure is equal to or lower than 1E−4 Pa, that is, when the pressure in the chamber 10 is equal to or lower than 1E−4 Pa, the processor 120 proceeds to step SP45. When the measured pressure is higher than 1E−4 Pa, that is, when the pressure in the chamber 10 is higher than 1E−4 Pa, the processor 120 returns to step SP44.

(Step SP45) The present step is a step in which the processor 120 determines whether the atmosphere exhaust time t1 has elapsed since the pressure in the chamber 10 becomes equal to or lower than 1E−4 Pa. The processor 120 starts clocking at a timing at which the measured pressure has become equal to or lower than 1E−4 Pa and determines whether the measured time period exceeds the atmosphere exhaust time t1.

When the measured time period does not exceed the atmosphere exhaust time t1, the processor 120 returns to step SP45. When the measured time period exceeds the atmosphere exhaust time t1, the processor 120 proceeds to step SP46.

(Step SP46) The present step is a step in which the processor 120 closes the valve V1. After closing the valve V1, the processor 120 proceeds to step SP47.

(Step SP47) The present step is a step in which the processor 120 opens the valve V2 and causes the supply device 17 to start supplying the purge gas. After opening the valve V2, the processor 120 proceeds to step SP48.

(Step SP48) The present step is a step in which the processor 120 determines whether the pressure measured by the pressure sensor 26 is equal to or higher than 1 atm being the fourth threshold. When the measured pressure is equal to or higher than 1 atm, that is, when the pressure in the chamber 10 is equal to or higher than 1 atm, the processor 120 proceeds to step SP49. When the measured pressure is lower than 1 atm, that is, when the pressure in the chamber 10 is lower than 1 atm, the processor 120 returns to step SP48.

(Step SP49) The present step is a step in which the processor 120 closes the valve V2. After closing the valve V2, the processor 120 proceeds to step SP50.

(Step SP50) The present step is a step in which the processor 120 counts up the exhaust count N. The processor 120 adds 1 to the exhaust count N. After adding 1 to the exhaust count N, the processor 120 proceeds to step SP51.

(Step SP51) The present step is a step in which the processor 120 opens the valve V1 and causes the exhaust device 16 to start exhaust. After opening the valve V1, the processor 120 proceeds to step SP52.

(Step SP52) The present step is a step in which the processor 120 determines whether the pressure measured by the pressure sensor 26 is equal to or lower than 1E−4 Pa. When the measured pressure is equal to or lower than 1E−4 Pa, that is, when the pressure in the chamber 10 is equal to or lower than 1E−4 Pa, the processor 120 proceeds to step SP53. When the measured pressure is higher than 1E−4 Pa, that is, when the pressure in the chamber 10 is higher than 1E−4 Pa, the processor 120 returns to step SP52.

(Step SP53) The present step is a step in which the processor 120 determines whether the purge gas exhaust time t2 has elapsed since the pressure in the chamber 10 becomes equal to or lower than 1E−4 Pa. The processor 120 starts clocking at a timing at which the measured pressure has become equal to or lower than 1E−4 Pa and determines whether the measured time period exceeds the purge gas exhaust time t2.

When the measured time period does not exceed the purge gas exhaust time t2, the processor 120 returns to step SP53. When the measured time period exceeds the purge gas exhaust time t2, the processor 120 proceeds to step SP54.

(Step SP54) The present step is a step in which the processor 120 determines whether the exhaust count N matches the number of exhaust times X. That is, the processor 120 determines whether the number of exhaust times by the exhaust device 16 has reached the number of exhaust times X.

When the exhaust count N matches the number of exhaust times X, the processor 120 ends the flowchart. When the exhaust count N does not match the number of exhaust times X, the processor 120 returns to step SP46.

In the present embodiment, the operation until YES is obtained through steps SP51 to SP53 is referred to as the exhaust operation. Further, the operation until YES is obtained through steps SP47 to SP48 is referred to as the supply operation.

When YES is obtained in step SP54, the processor 120 generates the EUV light 101 as in the first embodiment.

### 5.2 Effect

The EUV light generation apparatus 100 starts clocking after detecting the pressure in the chamber 10 having become equal to or lower than 1E−4 Pa. When the chamber 10 has been filled with the atmosphere, the EUV light generation apparatus 100 maintains the pressure in the chamber 10 until the measured time period passes the atmosphere exhaust time t1. Further, when the chamber 10 has been filled with the purge gas, the EUV light generation apparatus 100 maintains the pressure in the chamber 10 until the measured time period passes the purge gas exhaust time t2. Therefore, the EUV light generation apparatus 100 can more reliably maintain the pressure in the chamber 10 from when the pressure in the chamber 10 becomes equal to or lower than 1E−4 Pa until the atmosphere exhaust time t1 or the purge gas exhaust time t2 elapses. Accordingly, the EUV light generation apparatus 100 can more reliably set the oxygen partial pressure in the air gap 190 to be equal to or lower than the first threshold. Therefore, the EUV light generation apparatus 100 can more reliably suppress generation of tin oxide in the nozzle 42.

Here, the processor 120 may calculate and set the atmosphere exhaust time t1 and the purge gas exhaust time t2 based on the input data as in the modification of the first embodiment.

### 6. Description of Extreme Ultraviolet Light Generation Chamber Device of Fourth Embodiment

Next, the configuration of the EUV light generation apparatus 100 of a fourth embodiment will be described. Any component same as that described above is denoted by an identical reference sign, and duplicate description thereof is omitted unless specific description is needed.

The EUV light generation apparatus 100 of the fourth embodiment differs from the EUV light generation apparatus 100 of the first embodiment in that the second threshold is changed in accordance with what round o 41 the exhaust operation. The EUV light generation apparatus 100 changes the target pressure in the chamber 10 for each round of the exhaust operation.

### 6.1 Operation

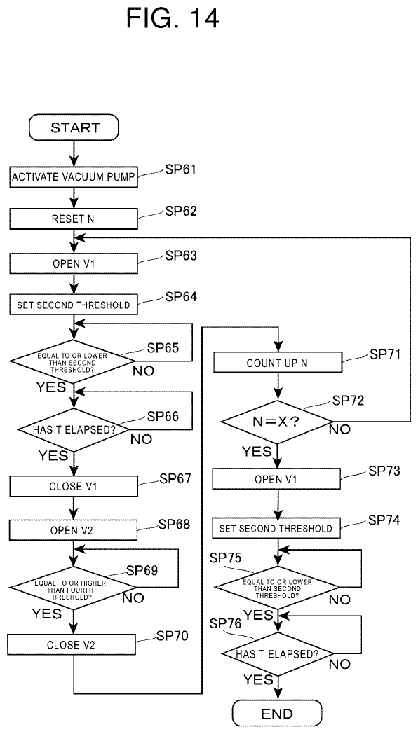

Operation of the EUV light generation apparatus 100 of the present embodiment will be described. FIG. 14 is a flowchart for explaining the operation of the EUV light generation apparatus 100. The processor 120 actualizes the following operation by executing a program stored in an internal memory or the like. As shown in FIG. 14, the flowchart includes steps SP61 to SP76.

At the beginning of the flowchart explained below, the chamber 10 is filled with the atmosphere of 1 atm, and the valve V1 and the valve V2 are closed. Further, the processor 120 sets the exhaust time T with reference to the parameter table or the like. In the present embodiment, the parameter table indicates the second threshold for each round of the exhaust operation, and the processor 120 may set the second threshold for each round of the exhaust operation with reference to the parameter table.

(Step SP61) The present step is a step in which the processor 120 of the EUV light generation apparatus 100 activates the vacuum pump 161. After activating the vacuum pump 161, the processor 120 proceeds to step SP62.

(Step SP62) The present step is a step in which the processor 120 resets the exhaust count N for counting the exhaust with the exhaust device 16. The processor 120 substitutes 1 for the exhaust count N. After substituting 1 for the exhaust count N, the processor 120 proceeds to step SP63.

(Step SP63) The present step is a step in which the processor 120 opens the valve V1 and causes the exhaust device 16 to start exhaust. After opening the valve V1, the processor 120 proceeds to step SP64.

(Step SP64) The present step is a step in which the processor 120 sets the second threshold in accordance with what round of the exhaust operation. For example, the processor 120 sets the second threshold in accordance with the exhaust count N. The processor 120 sets the second threshold with reference to the parameter table or the like. Further, in the present embodiment, the second threshold set in step SP64 is equal to or higher than 1E−4 Pa. After setting the second threshold, the processor 120 proceeds to step SP65.

(Step SP65) The present step is a step in which the processor 120 determines whether the pressure measured by the pressure sensor 26 is equal to or lower than the second threshold. When the measured pressure is equal to or lower than the second threshold, that is, when the pressure in the chamber 10 is equal to or lower than the second threshold, the processor 120 proceeds to step SP66. When the measured pressure is higher than the second threshold, that is, when the pressure in the chamber 10 is higher than the second threshold, the processor 120 returns to step SP65.

(Step SP66) The present step is a step in which the processor 120 determines whether the exhaust time T has elapsed since the pressure in the chamber 10 becomes equal to or lower than the second threshold. The processor 120 starts clocking at a timing at which the measured pressure has become equal to or lower than the second threshold and determines whether the measured time period exceeds the exhaust time T.

When the measured time period does not exceed the exhaust time T, the processor 120 returns to step SP66. When the measured time period exceeds the exhaust time T, the processor 120 proceeds to step SP67.

(Step SP67) The present step is a step in which the processor 120 closes the valve V1. After closing the valve V1, the processor 120 proceeds to step SP68.

(Step SP68) The present step is a step in which the processor 120 opens the valve V2 and causes the supply device 17 to start supplying the purge gas. After opening the valve V2, the processor 120 proceeds to step SP69.

(Step SP69) The present step is a step in which the processor 120 determines whether the pressure measured by the pressure sensor 26 is equal to or higher than 1 atm being the fourth threshold. When the measured pressure is equal to or higher than 1 atm, that is, when the pressure in the chamber 10 is equal to or higher than 1 atm, the processor 120 proceeds to step SP70. When the measured pressure is lower than 1 atm, that is, when the pressure in the chamber 10 is lower than 1 atm, the processor 120 returns to step SP69.

(Step SP70) The present step is a step in which the processor 120 closes the valve V2. After closing the valve V2, the processor 120 proceeds to step SP71.

(Step SP71) The present step is a step in which the processor 120 counts up the exhaust count N. The processor 120 adds 1 to the exhaust count N. After adding 1 to the exhaust count N, the processor 120 proceeds to step SP72.

(Step SP72) The present step is a step in which the processor 120 determines whether the exhaust count N matches the number of exhaust times X. That is, the processor 120 determines whether the number of exhaust times by the exhaust device 16 has reached the number of exhaust times X.

When the exhaust count N matches the number of exhaust times X, the processor 120 proceeds to step SP73. When the exhaust count N does not match the number of exhaust times X, the processor 120 returns to step SP63.

(Step SP73) The present step is a step in which the processor 120 opens the valve V1 and causes the exhaust device 16 to start exhaust. After opening the valve V1, the processor 120 proceeds to step SP74.

(Step SP74) The present step is a step in which the processor 120 sets 1E−4 Pa as the second threshold. The processor 120 sets the smallest value as the second threshold in the last round of the exhaust operation. After setting 1E−4 Pa as the second threshold, the processor 120 proceeds to step SP75.

(Step SP75) The present step is a step in which the processor 120 determines whether the pressure measured by the pressure sensor 26 is equal to or lower than the second threshold. When the measured pressure is equal to or lower than the second threshold, that is, when the pressure in the chamber 10 is equal to or lower than 1E−4 Pa, the processor 120 proceeds to step SP76. When the measured pressure is higher than the second threshold, that is, when the pressure in the chamber 10 is higher than 1E−4 Pa, the processor 120 returns to step SP75.

(Step SP76) The present step is a step in which the processor 120 determines whether the exhaust time T has elapsed since the pressure in the chamber 10 becomes equal to or lower than the second threshold. The processor 120 starts clocking at a timing at which the measured pressure has become equal to or lower than the second threshold and determines whether the measured time period exceeds the exhaust time T.

When the measured time period does not exceed the exhaust time T, the processor 120 returns to step SP76. When the measured time period exceeds the exhaust time T, the processor 120 ends the flowchart.

In the present embodiment, the operation until YES is obtained through steps SP63 to SP66 and the operation until YES is obtained through steps SP73 to SP76 when the chamber 10 is filled with the purge gas are referred to as the exhaust operation. Further, the operation until YES is obtained through steps SP68 to SP69 is referred to as the supply operation.

When YES is obtained in step SP76, the processor 120 generates the EUV light 101 as in the first embodiment.

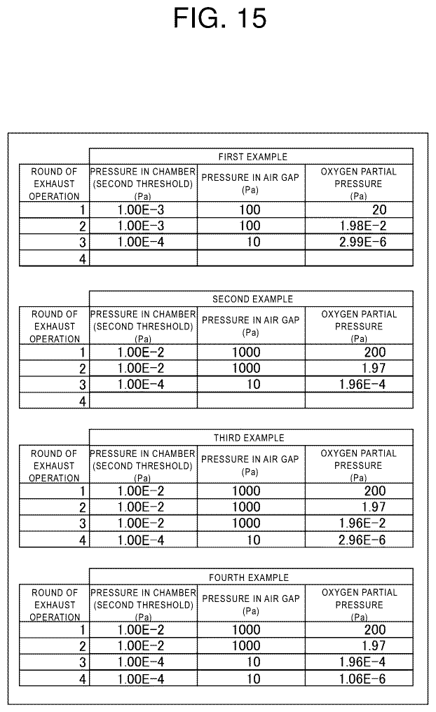

Next, the relationship between the pressure in the chamber 10, which is the second threshold for each round, and the oxygen partial pressure in the air gap 190 will be described. FIG. 15 is a table showing the relationship between the second threshold for each round and the oxygen partial pressure in the air gap 190. FIG. 15 shows first to fourth examples.

In the examples shown in FIG. 15, the exhaust device 16 exhausts the atmosphere from the inside of the chamber 10 in the first exhaust operation of each example, and exhausts the purge gas from the inside of the chamber 10 in the second and subsequent exhaust operation.

In the first exhaust operation of the first example, the EUV light generation apparatus 100 sets 1.00E−3 Pa as the second threshold. The EUV light generation apparatus 100 lowers the pressure in the chamber 10 to 1.00E−3 Pa in the first exhaust operation. In the first example, the pressure in the air gap 190 is 100 Pa when the first exhaust operation is completed. As described above, the pressure in the air gap 190 is approximately five orders of magnitude greater than the pressure in the chamber 10. When the exhaust time T elapses and the pressure in the air gap 190 becomes 100 Pa, the oxygen partial pressure in the air gap 190 is 20 Pa.

Even in the second exhaust operation, the EUV light generation apparatus 100 sets 1.00E−3 Pa as the second threshold. The oxygen partial pressure in the air gap 190 when the second exhaust operation is completed is 1.98E−2 Pa.

In the third exhaust operation, the EUV light generation apparatus 100 sets 1.00E−4 Pa as the second threshold. The oxygen partial pressure in the air gap 190 when the third exhaust operation is completed is 2.99E−6 Pa.

In the first example, when the third exhaust operation is completed, the oxygen partial pressure in the air gap 190 becomes equal to or lower than 1E−5 Pa being the first threshold. Therefore, the EUV light generation apparatus 100 can effectively suppress generation of tin oxide in the air gap 190 by setting the second threshold as in the first example.

Next, the second example will be described. In the first exhaust operation of the second example, the EUV light generation apparatus 100 sets 1.00E−2 Pa as the second threshold. The EUV light generation apparatus 100 lowers the pressure in the chamber 10 to 1E−2 Pa in the first exhaust operation. In the second example, the pressure in the air gap 190 is 1000 Pa when the first exhaust operation is completed. When the exhaust time T elapses and the pressure in the air gap 190 becomes 1000 Pa, the oxygen partial pressure in the air gap 190 is 200 Pa.

Even in the second exhaust operation, the EUV light generation apparatus 100 sets 1.00E−2 Pa as the second threshold. The oxygen partial pressure in the air gap 190 when the second exhaust operation is completed is 1.97 Pa.

In the third exhaust operation, the EUV light generation apparatus 100 sets 1.00E−4 Pa as the second threshold. The oxygen partial pressure in the air gap 190 when the third exhaust operation is completed is 1.96E−4 Pa.

In the second example, the oxygen partial pressure in the air gap 190 does not become equal to or lower than 1E−5 Pa being the first threshold when the third exhaust operation is completed.

Next, the third example will be described. In the first exhaust operation of the third example, the EUV light generation apparatus 100 sets 1.00E−2 Pa as the second threshold. The EUV light generation apparatus 100 lowers the pressure in the chamber 10 to 1.00E−2 Pa in the first exhaust operation. In the third example, the pressure in the air gap 190 is 1000 Pa when the first exhaust operation is completed. When the exhaust time T elapses and the pressure in the air gap 190 becomes 1000 Pa, the oxygen partial pressure in the air gap 190 is 200 Pa.

Even in the second exhaust operation, the EUV light generation apparatus 100 sets 1.00E−2 Pa as the second threshold. The oxygen partial pressure in the air gap 190 when the second exhaust operation is completed is 1.97 Pa.

Even in the third exhaust operation, the EUV light generation apparatus 100 sets 1.00E−2 Pa as the second threshold. The oxygen partial pressure in the air gap 190 when the third exhaust operation is completed is 1.96E−2 Pa.

In the fourth exhaust operation, the EUV light generation apparatus 100 sets 1.00E−4 Pa as the second threshold. The oxygen partial pressure in the air gap 190 when the fourth exhaust operation is completed is 2.96E−6 Pa.

In the third example, when the fourth exhaust operation is completed, the oxygen partial pressure in the air gap 190 becomes equal to or lower than 1E−5 Pa being the first threshold. Therefore, the EUV light generation apparatus 100 can effectively suppress generation of tin oxide in the air gap 190 by setting the second threshold as in the third example.

Next, the fourth example will be described. In the first exhaust operation of the fourth example, the EUV light generation apparatus 100 sets 1.00E−2 Pa as the second threshold. The EUV light generation apparatus 100 lowers the pressure in the chamber 10 to 1.00E−2 Pa in the first exhaust operation. In the fourth example, the pressure in the air gap 190 is 1000 Pa when the first exhaust operation is completed. When the exhaust time T elapses and the pressure in the air gap 190 becomes 1000 Pa, the oxygen partial pressure in the air gap 190 is 200 Pa.

Even in the second exhaust operation, the EUV light generation apparatus 100 sets 1.00E−2 Pa as the second threshold. The oxygen partial pressure in the air gap 190 when the second exhaust operation is completed is 1.97 Pa.

In the third exhaust operation, the EUV light generation apparatus 100 sets 1.00E−4 as the second threshold. The oxygen partial pressure in the air gap 190 when the third exhaust operation is completed is 1.96E−4 Pa.

In the fourth exhaust operation, the EUV light generation apparatus 100 sets 1.00E−4 Pa as the second threshold. The oxygen partial pressure in the air gap 190 when the fourth exhaust operation is completed is 1.06E−6 Pa.

In the fourth example, the oxygen partial pressure in the air gap 190 becomes equal to or lower than 1E−5 Pa being the first threshold when the fourth exhaust operation is completed. Therefore, the EUV light generation apparatus 100 can effectively suppress generation of tin oxide in the air gap 190 by setting the second threshold as in the fourth example.

As described above, when the second threshold is set as in the first, third, and fourth examples, the EUV light generation apparatus 100 may set the oxygen partial pressure in the air gap 190 to be equal to or lower than 1E−5 Pa being the first threshold. Therefore, the EUV light generation apparatus 100 can more effectively suppress generation of tin oxide.

### 6.2 Effect

By changing the second threshold, the EUV light generation apparatus 100 can change the time period required for each round of the exhaust operation. Therefore, the EUV light generation apparatus 100 can adjust the time period until the oxygen partial pressure in the air gap 190 becomes equal to or less than the first threshold.

Here, the processor 120 may set the smallest value as the second threshold in any round other than the last round.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined. The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. An extreme ultraviolet light generation chamber device comprising:
a chamber in which a target substance irradiated with laser is turned into plasma and extreme ultraviolet light is generated;
a tank configured to store the target substance;
a nozzle having an internal space which communicates with the tank and the chamber;
an exhaust device configured to exhaust the chamber;
a supply device configured to supply a purge gas to the chamber;
a pressure sensor configured to measure a pressure in the chamber; and
a processor,
the processor causing, before the target substance is melted, the exhaust device to exhaust a gas from the chamber, and after the gas is exhausted, performing supply operation to cause the supply device to supply the purge gas into the chamber and exhaust operation to cause the exhaust device to exhaust the purge gas from the chamber.

2. The extreme ultraviolet light generation chamber device according to claim 1,
wherein the processor repeats the supply operation and the exhaust operation until an oxygen partial pressure in an air gap generated between the target substance existing in the internal space and an inner wall of the nozzle defining the internal space becomes lower than a first threshold.

3. The extreme ultraviolet light generation chamber device according to claim 2,
wherein the target substance is tin.

4. The extreme ultraviolet light generation chamber device according to claim 3,
wherein the first threshold is 1E−5 Pa.

5. The extreme ultraviolet light generation chamber device according to claim 2,
wherein the processor causes the exhaust device to exhaust the purge gas from the chamber for a specific exhaust time in the exhaust operation.

6. The extreme ultraviolet light generation chamber device according to claim 5,
wherein the specific exhaust time is a sum of a time period until the pressure in the chamber becomes equal to or lower than a second threshold and a time period until a pressure in the air gap becomes equal to or lower than a third threshold after the pressure in the chamber becomes equal to or lower than the second threshold.

7. The extreme ultraviolet light generation chamber device according to claim 6,
wherein the second threshold is 1E−4 Pa.

8. The extreme ultraviolet light generation chamber device according to claim 7,
wherein the third threshold is 10 Pa.

9. The extreme ultraviolet light generation chamber device according to claim 1,
wherein the processor causes the supply device to supply the purge gas to the chamber until the pressure in the chamber becomes equal to or higher than a fourth threshold in the supply operation.

10. The extreme ultraviolet light generation chamber device according to claim 9,
wherein the fourth threshold is 1 atmospheric pressure.

11. The extreme ultraviolet light generation chamber device according to claim 2,
wherein the processor starts clocking after the pressure in the chamber becomes equal to or lower than a second threshold in the exhaust operation.

12. The extreme ultraviolet light generation chamber device according to claim 11,
wherein the processor causes the exhaust device to exhaust the purge gas until a specific purge gas exhaust time elapses after starting the clocking in the exhaust operation.

13. The extreme ultraviolet light generation chamber device according to claim 12,
wherein the specific purge gas exhaust time is a time period until a pressure in the air gap becomes equal to or lower than a third threshold after the pressure in the chamber becomes equal to or lower than the second threshold.

14. The extreme ultraviolet light generation chamber device according to claim 11,
wherein the second threshold differs in accordance with what round of the exhaust operation.

15. The extreme ultraviolet light generation chamber device according to claim 14,
wherein the second threshold in a last round of the exhaust operation is the smallest.

16. The extreme ultraviolet light generation chamber device according to claim 5,
wherein the processor calculates the specific exhaust time and a number of times to perform the supply operation and the exhaust operation based on an opening diameter and an opening ratio of the nozzle, a volume of the air gap, and a molecular weight and an oxygen concentration of the purge gas.

17. The extreme ultraviolet light generation chamber device according to claim 1,
wherein the gas is atmosphere.

18. The extreme ultraviolet light generation chamber device according to claim 1,
wherein the processor causes the exhaust device to exhaust the gas from the chamber for a first exhaust time, and in the exhaust operation, to exhaust the purge gas from the chamber for a second exhaust time being different from the first exhaust time.

19. An electronic device manufacturing method, comprising:
outputting extreme ultraviolet light generated using an extreme ultraviolet light generation apparatus including an extreme ultraviolet light generation chamber device to an exposure apparatus; and
exposing a photosensitive substrate to the extreme ultraviolet light in the exposure apparatus to manufacture an electronic device,
the extreme ultraviolet light generation chamber device including:
a chamber in which a target substance irradiated with laser is turned into plasma and the extreme ultraviolet light is generated;
a tank configured to store the target substance;
a nozzle having an internal space which communicates with the tank and the chamber;
an exhaust device configured to exhaust the chamber;
a supply device configured to supply a purge gas to the chamber;
a pressure sensor configured to measure a pressure in the chamber; and
a processor,
the processor causing, before the target substance is melted, the exhaust device to exhaust a gas from the chamber, and after the gas is exhausted, performing supply operation to cause the supply device to supply the purge gas into the chamber and exhaust operation to cause the exhaust device to exhaust the purge gas from the chamber.

20. An electronic device manufacturing method, comprising:
inspecting a defect of a mask by irradiating the mask with extreme ultraviolet light generated using an extreme ultraviolet light generation apparatus including an extreme ultraviolet light generation chamber device;
selecting a mask using a result of the inspection; and
exposing and transferring a pattern formed on the selected mask onto a photosensitive substrate,
the extreme ultraviolet light generation chamber device including:
a chamber in which a target substance irradiated with laser is turned into plasma and the extreme ultraviolet light is generated;
a tank configured to store the target substance;
a nozzle having an internal space which communicates with the tank and the chamber;
an exhaust device configured to exhaust the chamber;
a supply device configured to supply a purge gas to the chamber;
a pressure sensor configured to measure a pressure in the chamber; and
a processor,
the processor causing, before the target substance is melted, the exhaust device to exhaust a gas from the chamber, and after the gas is exhausted, performing supply operation to cause the supply device to supply the purge gas into the chamber and exhaust operation to cause the exhaust device to exhaust the purge gas from the chamber.
